(19) United States
(12) Patent Application Publication
(10) Pub. No.: US 2016/0124290 A1
(43) Pub. Date: May 5, 2016

(54) DUAL LENS MOUNT ON A MOBILE DEVICE CASE

(71) Applicant: Hit Technologies Inc., Vancouver (CA)

(72) Inventors: Brooks Bergreen, Vancouver (CA); David Keddie Brown, Vancouver (CA)

(21) Appl. No.: 14/921,566

(22) Filed: Oct. 23, 2015

Related U.S. Application Data
(60) Provisional application No. 62/072,920, filed on Oct. 30, 2014.

(51) Int. Cl. G03B 17/56; H04N 5/225; G02B 7/02; G02B 7/14; G03B 17/14

(52) U.S. Cl. CPC G03B 17/565; G02B 7/14; G03B 17/14; G02B 7/022; H04N 5/2254; H04N 5/2252

(57) ABSTRACT

A camera lens and a mobile device case for mounting the camera lens are provided. The camera lens may include a dual mount to allow the lens to couple to a variety of receiving mounts on the mobile device case. The dual mount may comprise first and second mounting systems, such as a bayonet mounting system and a screw mount system.

### CROSS-REFERENCE TO RELATED APPLICATIONS

The present application claims the benefit of U.S. Provisional Application No. 62/072,920, filed on Oct. 30, 2014, the entire disclosure of which is hereby incorporated by reference for all purposes.

### FIELD OF THE DISCLOSURE

The present disclosure relates generally to the field of photographic equipment, and more specifically to a dual mount camera lens and a mobile device case to accept the dual mount camera lens.

### SUMMARY

The present disclosure is directed a camera lens. An exemplary camera lens may comprise a lens body. One or more lens elements may be positioned within the lens body. The lens body may have a first mounting section comprising a first mounting system. The lens body may further have a second mounting section comprising a second mounting system.

According to additional exemplary embodiments, the present disclosure may be directed to a camera lens. An exemplary camera lens may comprise a lens body with one or more lens elements positioned within the lens body. The lens body may have a first mounting section and a second mounting section. The first mounting section may comprise a first mounting system and may have a first diameter. The second mounting section may comprise a second mounting system and may have a second diameter different from the first diameter.

According to further exemplary embodiments, the present disclosure may be directed to a case for a mobile device. The case may comprise a case body with a camera lens receiving mount. The camera lens receiving mount may form an opening in the case body. The opening may be positioned over a camera on the mobile device when the mobile device is in the case. A camera lens assembly having a lens body may be releasably coupled to the camera lens receiving mount. The lens body may comprise a first mounting section with a first mounting system, and a second mounting section with a second mounting system. The camera lens receiving mount may be adapted to receive one of the first or second lens mounting systems.

### BRIEF DESCRIPTION OF THE DRAWINGS

FIG. 1A is a front view of a dual mount camera lens according to various embodiments.

FIG. 1B is a side cross-sectional view of a dual mount camera lens according to various embodiments.

FIG. 2 is an exploded side cross-sectional view of a dual mount camera lens according to various embodiments.

FIG. 3 is a perspective view of a dual mount camera lens and a mobile device case according to various embodiments.

FIG. 4A is a detail view of a dual mount camera lens mated to a mobile device case according to various embodiments.

FIG. 4B is a detail view of a dual mount camera lens mated to a mobile device case according to various embodiments.

FIG. 5 is a side view of a dual mount camera lens mated to a mobile device case according to various embodiments.

FIG. 6 is a perspective view of a dual mount camera lens and a mobile device case according to various embodiments.

FIG. 7 is a detail view of a dual mount camera lens mated to a mobile device case according to various embodiments.

FIG. 8 is a cross-sectional detail view of a dual mount camera lens mated to a mobile device case according to various embodiments.

### DETAILED DESCRIPTION

The present disclosure is directed to a various embodiments of a dual mount camera lens and a mobile device case to receive the dual mount camera lens. The dual mount camera lens may comprise a dual mount that may serve as a coupling interface between the mobile device case and the dual mount camera lens. The types of mobile device cases used in conjunction with the dual mount camera lens may include, but are not limited to, those described in U.S. Pat. No. 8,770,402 titled, “Waterproof Protective Case for a Mobile Device,” U.S. patent application Ser. No. 13/750,706 titled, “Providing a Rail Mounting System for a Mobile Device Case,” and U.S. patent application Ser. No. 13/441,564 titled, “Mobile Device Case Having an Integrated Wide Angle Lens,” this patent and these patent applications being related to the present disclosure and incorporated by reference. The lens that is included in the dual mount camera lens may be of any focal length.

Mobile devices often comprise a camera with the ability to record photographs and/or video. The mobile device camera may comprise at least one lens and an image sensor. Often, the mobile device camera lens is a fixed-focus lens. The fixed-focus lens may be given a non-adjustable focus at the point of manufacture. In addition, the mobile device camera may have a fixed field of view. The field of view of a camera lens is the visible extent of the image recorded by the image sensor, commonly stated as an angle. These built-in restrictions on the operation of the mobile device camera may significantly restrict the photographic ability of a user, as well as impose limits as to where and how the mobile device cameral may be used.

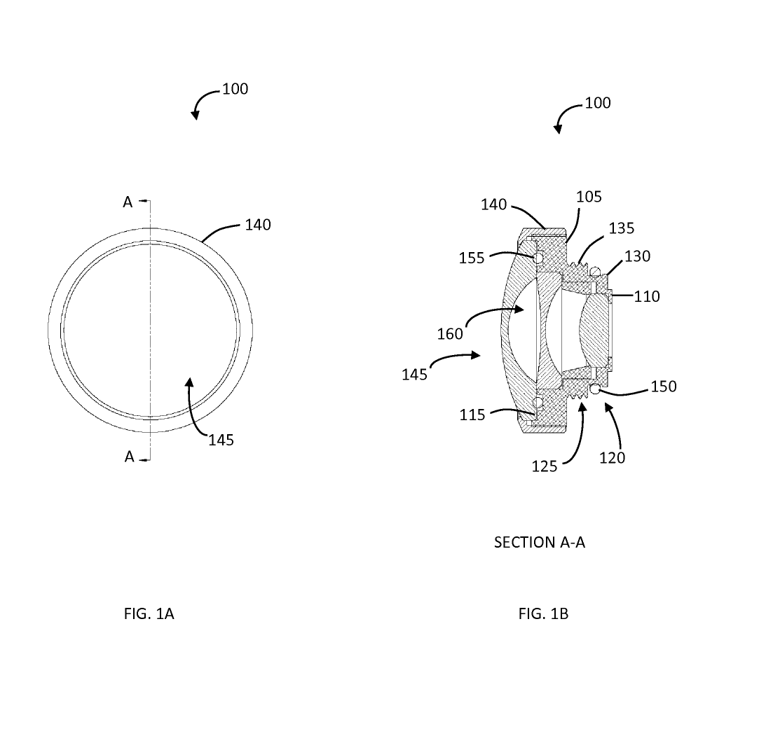

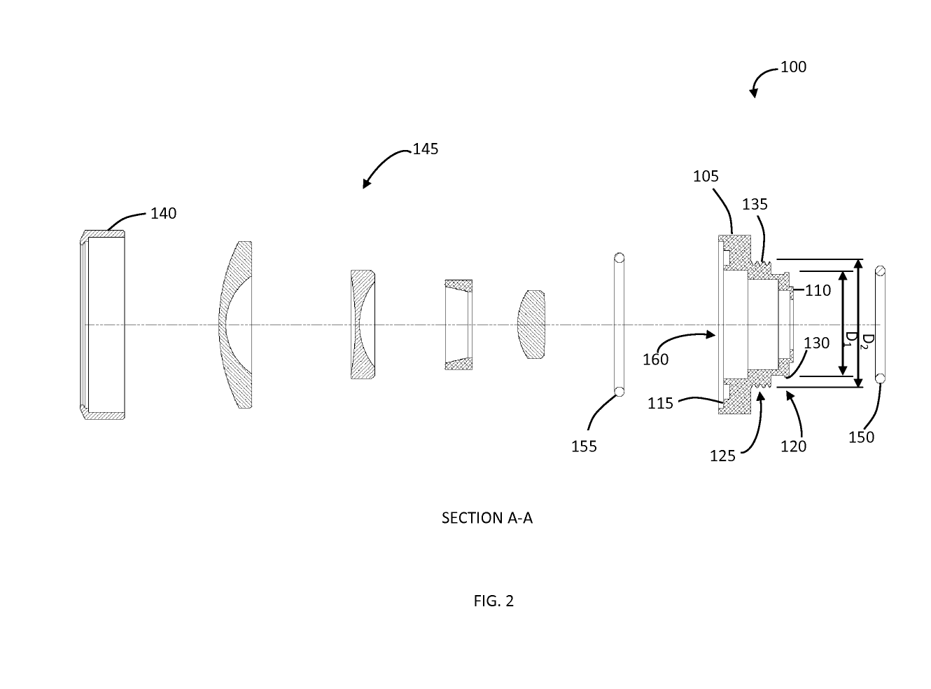

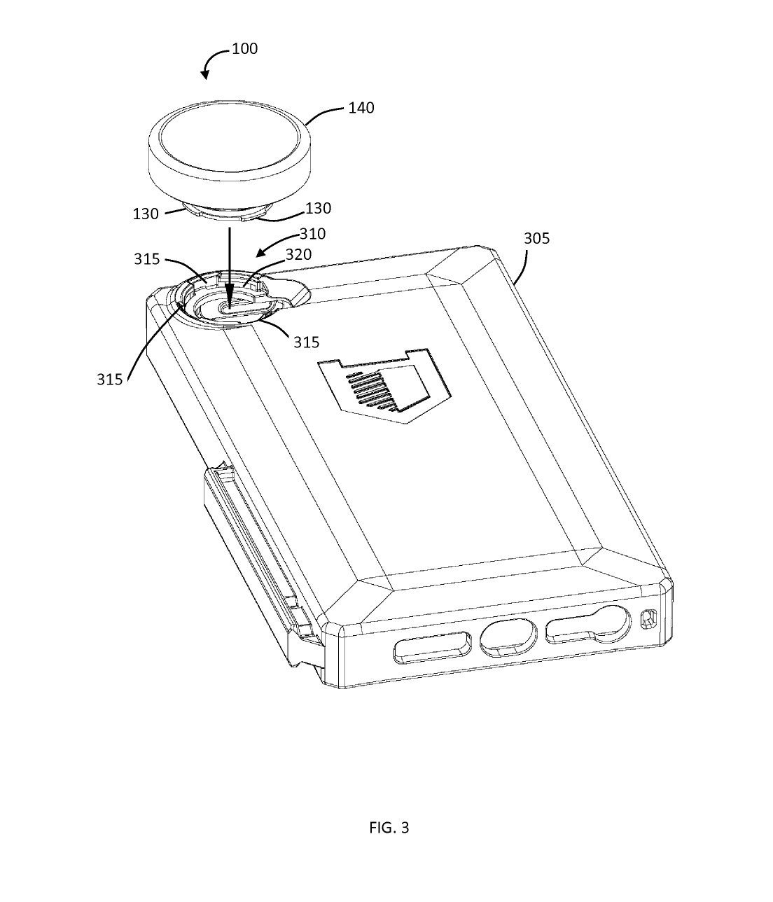

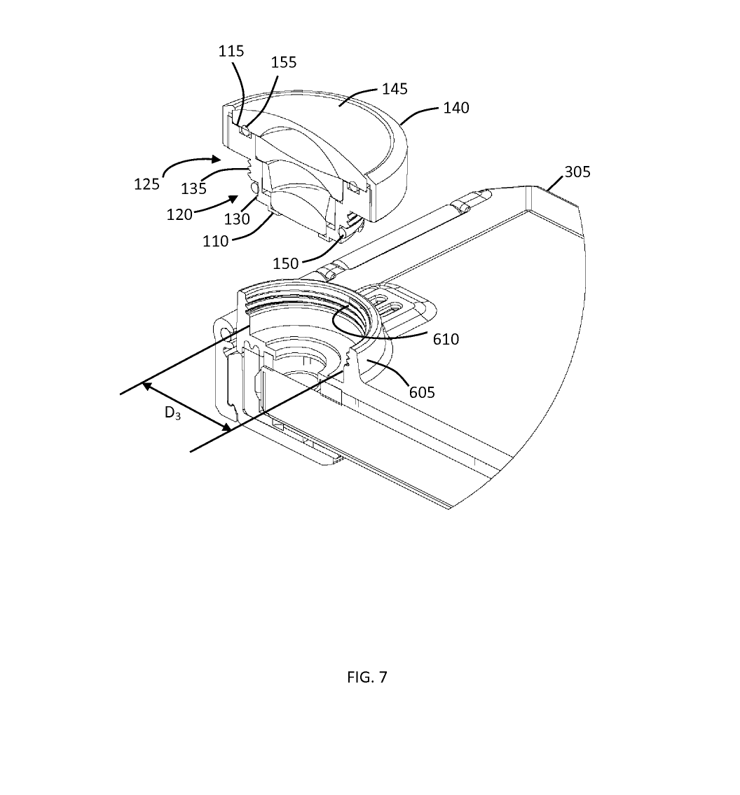

FIGS. 1A, 1B and 2 illustrate various embodiments of a dual mount camera lens 100. The dual mount camera lens 100 may comprise a lens body 105, which may further comprise a first mounting section 120 and a second mounting section 125. The lens body 105, first mounting section 120, and second mounting section 125 may each be generally round in cross-sectional shape and may all be arranged along a common centerline (see FIG. 2). The lens body 105 may further comprise an interior end 110 and an exterior end 115. The interior end 110 may be positioned within an opening on the mobile device case (see, for example, FIGS. 3-8). The exterior end 115 may be positioned outside the mobile device case when the dual mount camera lens 100 is coupled to the mobile device case.

One or more lens elements 145 may be positioned completely or partially in a hollow interior chamber 160 within the lens body 105. As will be apparent to one skilled in the art, the lens elements 145 may comprise a single lens or multiple lenses as required to provide the dual mount camera lens 100 with a desired optical functionality. For example, a certain arrangement of lens elements 145 may be selected to provide macro focusing ability, while a different arrangement of lens elements 145 may be selected to provide a wide angle field of view. Any selection or arrangement of lens elements 145 is within the scope of the present disclosure.

The dual mount camera lens 100 may further comprise one or more O-rings, such as interior O-ring 150 and exterior O-ring 155 to help prevent moisture and particulate contamination to enter the hollow interior chamber 160 of the lens body 105. Further, a cap 140 may be coupled to the lens body exterior end 115 to seal the dual mount camera lens 100 and secure the lens elements 145.

As illustrated in FIG. 2, the first mounting section 120 may have a first exterior diameter D₁ and the second mounting section 125 may have a second exterior diameter D₂. According to various embodiments, D₁ may be less than D₂. As explained further below, when utilizing the second mounting section 125 to couple the dual mount camera lens 100 to the mobile device case (shown as 305 in FIGS. 3 through 8) the smaller diameter D₁ of the first mounting section 120 may allow the first mounting section 120 to pass through an opening on the mobile device case 305 sized for the larger diameter D₂ of the second mounting section 125. Such functionality may not be possible where D₁ is equal to or greater than D_{2.}

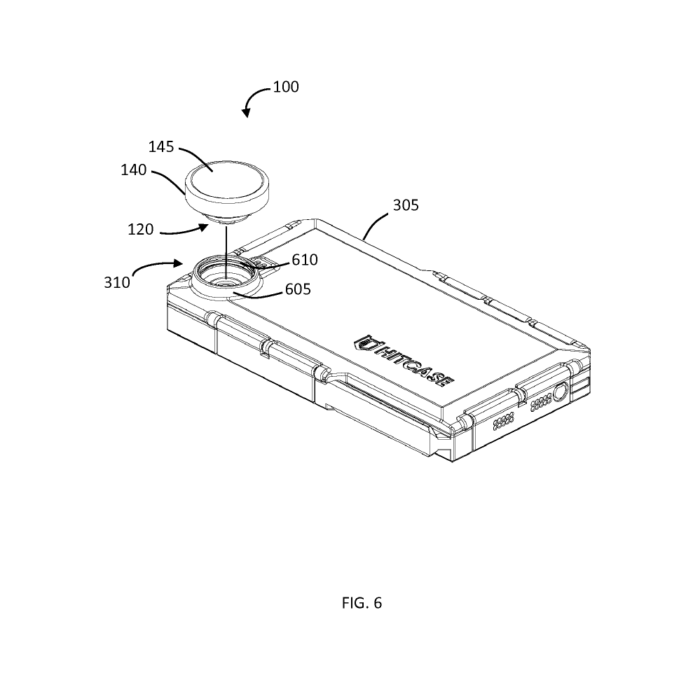

Various embodiments of the first mounting section 120 and the second mounting section 125 may comprise different mounting systems. For example, the first mounting section 120 may comprise a plurality of mounting flanges 130 radially disposed around the first mounting section 120 (also illustrated in FIG. 3). The mounting flanges 130 may mate to one or more slots (shown as 315 in FIG. 3) in the mobile device case 305. This type of mounting system is commonly referred to as a “bayonet mount.” As an additional example, the second mounting section 125 may comprise screw threads 135 that may mate with corresponding threads (shown as 610 in FIG. 6) in the mobile device case 305. The functionality of each of these mounting systems according to various embodiments is described in more detail below.

The mounting flanges 130 may be equally or unequally disposed around the first mounting section 120. Each of the mounting flanges 130 may be the same shape and size, or one or more of the mounting flanges may be shaped or sized differently than the others. For example, one of the mounting flanges 130 may be slightly larger than the other mounting flanges 130 to assure proper orientation and alignment between the dual mount camera lens 100 and the mobile device case 305.

Although not shown, certain embodiments of the first mounting section 120 and the second mounting section 125 may comprise the same mounting system. For example, both the first mounting section 120 and the second mounting section 125 may comprise screw threads 135. The different diameters D₁ and D₂ of the first and second mounting sections 120, 125, respectively, may allow the dual mount camera lens 100 to mount to different diameter screw mounts.

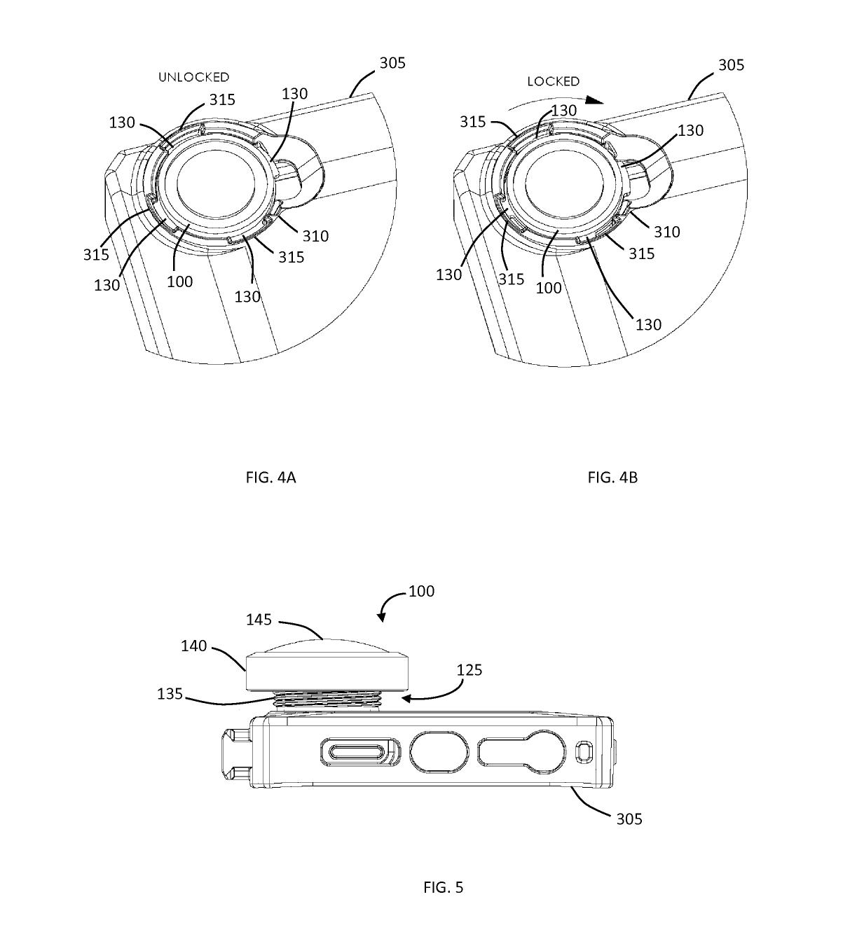

Turning now to FIGS. 3 through 5, various embodiments of the first mounting section 120 of the dual mount camera lens assembly 100 and the mobile device case 305 utilizing a bayonet mounting system are illustrated. FIG. 3 shows the dual mount camera lens 100 positioned over a receiving mount 310 of the mobile device case 305. The receiving mount 310 may comprise a plurality of flange receiving slots 315 adapted to receive the mounting flanges 130 therein when the first mounting section 120 of the dual mount camera lens 100 is positioned within the receiving mount 310. FIG. 4A illustrates the first mounting section 120 of the dual mount camera lens 100 positioned within the receiving mount 310. The receiving mount 310 may further comprise flange locking slots 320 positioned in a L-shaped arrangement with the flange receiving slots 315. After positioning the first mounting section 120 within the receiving mount 310, the mounting flanges 130 may engage the flange locking slots 320 when the dual mount camera lens 100 is rotated as shown in FIG. 4B. The flange locking slots 320 may comprise one or more detents, springs, interlocking surfaces, and the like to capture the mounting flanges 130 and thereby removably couple the dual mount camera lens 100 to the mobile device case 305.

FIG. 5 illustrates an end view of the mobile device case 305 according to various embodiments with the dual mount camera lens 100 coupled to the receiving mount 310. The second mounting section 125 is shown outside the receiving mount 310 because the second mounting section 125 is not utilized in this embodiment. Due to the larger diameter D₂, the second mounting section 125 will not fit within the receiving mount 310 which in this embodiment is sized for the smaller diameter D₁ of the first mounting section 120.

FIGS. 6 through 8 illustrate various embodiments of the second mounting section 125 of the dual mount camera lens 100 and the mobile device case 305 utilizing a screw mounting system. The mobile device case 305 may comprise a thread mount receiver 605 having receiver threads 610 on an inner surface. The thread mount receiver 605 may have a diameter D₃ sized to receive the screw threads 135 of the second mounting section 125. The diameter D₃ is larger than the diameter D₁ of the first mounting section 120 so that the first mounting section 120 may pass through the thread mount receiver 605 so that the screw threads 135 of the second mounting section 125 can engage the receiver threads 610 of the thread mount receiver 605.

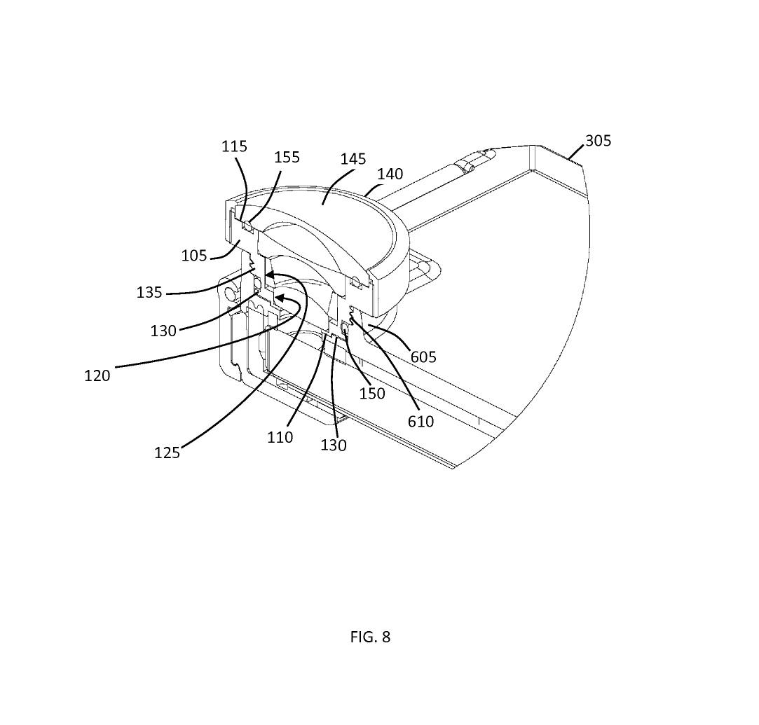

Once the screw threads 135 of the second mounting section 125 engage the receiver threads 610 of the thread mount receiver 605, the dual mount camera lens 100 may be rotated until the second mounting section 125 is fully engaged with the thread mount receiver 605 as illustrated in FIG. 8.

In various embodiments, one or both of the first mounting section 120 and the second mounting section 125 may comprise, in whole or in part, a magnetic material. The corresponding receiving mount 310 or receiver 605 on the mobile device case 305 may also comprise a magnetic material (of opposite polarity than the magnetic material of the first mounting section 120 or the second mounting section 125) in whole or in part, or may be made of a metallic material that is attracted to a magnet (such as, but not limited to ferrous, nickel, and cobalt alloys). Thus, rather than a purely mechanical connection between the dual mount camera lens 100 and the mobile device case 305 as provided by the exemplary bayonet or screw mounts, the connection may be facilitated by a magnetic force. In various embodiments, the magnets may be in place of or in addition to the mechanical connection (e.g., bayonet or screw mount).

Although the exemplary embodiments of FIGS. 1 through 8 are described in relation to bayonet mounts and screw thread mounts, one skilled in the art will readily recognize that any mounting system is within the scope of the present disclosure. The types of mounting systems that may be utilized include, but are not limited to, A-mount, AR-mount, C-mount, CS-mount, D-mount, F-mount, Pentax K-mount, M-mount, M39-mount, PL-mount, PV-mount, R-mount, S-mount, SR-mount, T-mount, V-mount, X-mount, breech-lock, and the like, including other manufacturer-specific mounting systems from Aaton, Arri, Canon, Contax, Diana, Exakta, Fujica, Fujifilm, Hasselblad, Kodak, Konica, Leica, Mamiya, Minolta, Miranda, Nikon, Olympus, Pentacon, Pentax, Rollei, Sigma, Samsung, Sony, Topcon, Yashika, and the like. The mounting systems of the present disclosure may be mechanical or mechanical and electrical.

The mobile device case 305 may be of any appropriate size to receive a mobile device. The mobile device case 305 may also be composed of any suitable material or combination of materials, such as plastic, metal and rubber. In an exemplary embodiment, the mobile device case 305 or a portion thereof may be composed of a shock-adsorptive material, such as rubber or foam. While encased in the mobile device case 305, external forces, such as impacts from being dropped, may be absorbed by the shock-absorptive material, thereby providing protection to the mobile device from shock. The mobile device case 305 may also be water-resistant, thereby reducing exposure of the mobile device to contaminants. In an exemplary embodiment, the mobile device may be surrounded by the shock-absorptive material when placed in the mobile device case 305. Furthermore, in various embodiments, the mobile device case 305 may be designed to float on water, which may further reduce exposure of the mobile device to contaminates.

The mobile device case 305 may accommodate any mobile device having a camera. While the accompanying figures are generally directed to cellphone cases, the scope of the present disclosure extends to any mobile device which may be encased. Examples of mobile devices that may be used with embodiments of the mobile device case 305 and the dual mount camera lens 100 include, but are not limited to, portable computers, portable game consoles, portable music players, tablets, iPods®, iPhones®, cellphones, smartphones, portable navigation systems, digital cameras, and other similar devices.

The lens elements 145 may be composed of glass, quartz glass, fluorite, plastic, acrylic, germanium, meteoric glass, or any other material known in the art for making optical lenses. The lens elements 145 may be selected to provide a normal, non-distorted image, or may be selected to provide a desired distortion such as that achieved with a fisheye lens. The lens elements 145 may also be selected to provide a specified depth of field and angle of view. Additionally, the dual mount camera lens 100 may be fixed-focus or variable focus. In various embodiments, the dual mount camera lens 100 may have any functionality as is known in the art for photographic lenses.

While the present disclosure has been described in connection with a series of preferred embodiments, these descriptions are not intended to limit the scope of the disclosure to the particular forms set forth herein. The above description is illustrative and not restrictive. Many variations of the embodiments will become apparent to those of skill in the art upon review of this disclosure. The scope of this disclosure should, therefore, be determined not with reference to the above description, but instead should be determined with reference to the appended claims along with their full scope of equivalents. The present descriptions are intended to cover such alternatives, modifications, and equivalents as can be included within the spirit and scope of the disclosure as defined by the appended claims and otherwise appreciated by one of ordinary skill in the art. In several respects, embodiments of the present disclosure can act to close the loopholes in the current industry practices in which good business practices and logic are lacking because it is not feasible to implement with current resources and tools.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

What is claimed is:

1. A camera lens, comprising:
a lens body;
one or more lens elements mounted within the lens body;
a first mounting section on the lens body comprising a first mounting system; and
a second mounting section on the lens body comprising a second mounting system.

2. The camera lens of claim 1, wherein the lens body, the first mounting section, and the second mounting section each have a generally round cross-sectional shape and are all arranged along a common centerline.

3. The camera lens of claim 1, wherein the first mounting section extends from the second mounting system.

4. The camera lens of claim 1, wherein the first mounting section has a first diameter and the second mounting section has a second diameter greater than the first diameter.

5. The camera lens of claim 1, wherein the first and second mounting systems are different.

6. The camera lens of claim 5, wherein one of the first and second mounting systems comprises a plurality of radially arranged flanges, and the other of the first and second mounting systems comprises a screw thread.

7. The camera lens of claim 1, wherein the first and second mounting systems are the same.

8. The camera lens of claim 7, wherein the first and second mounting systems comprise a plurality of radially arranged flanges.

9. The camera lens of claim 7, wherein the first and second mounting systems comprise screw threads.

10. The camera lens of claim 1, wherein one or both of the first and second mounting systems are magnetic.

11. A camera lens, comprising:
a lens body;
one or more lens elements mounted within the lens body;
a first mounting section on the lens body comprising a first mounting system and having a first diameter; and
a second mounting section on the lens body comprising a second mounting system different from the first mounting system, and having a second diameter different from the first diameter.

12. The camera lens of claim 11, wherein the lens body, the first mounting section, and the second mounting section each have a generally round cross-sectional shape and are all arranged along a common centerline.

13. The camera lens of claim 11, wherein one of the first and second mounting systems comprises a plurality of radially arranged flanges, and the other of the first and second mounting systems comprises screw threads.

14. The camera lens of claim 11, wherein one or both of the first and second mounting systems are magnetic.

15. A case for a mobile device, comprising:
a case body to at least partially encase a mobile device;
a camera lens receiving mount on the case body forming an opening in the case body, the opening positioned over the mobile device when the mobile device is in the case body;
a camera lens comprising a lens body; and
a first mounting section and a second mounting section on the lens body, the first mounting section comprising a first lens mounting system and the second mounting section comprising a second lens mounting system, the camera lens receiving mount adapted to receive one of the first or second lens mounting systems.

16. The case of claim 15, wherein the first mounting section has a first diameter and the second mounting section has a second diameter greater than the first diameter.

17. The case of claim 15, wherein the lens body, the first mounting section, and the second mounting section each have a generally round cross-sectional shape and are all arranged along a common centerline.

18. The case of claim 15, wherein the first lens mounting system and the second lens mounting system are different.

19. The case of claim 18, wherein the camera lens receiving mount further comprises either the first lens mounting system or the second lens mounting system.

20. The case of claim 15, wherein the first and second lens mounting systems are the same.

21. The case claim 15, wherein one of the first and second mounting systems comprises a plurality of radially arranged flanges.

22. The case of claim 15, wherein one of the first and second mounting systems comprises screw threads.

23. The camera lens of claim 15, wherein one or both of the first and second mounting systems are magnetic.
